(19) United States
(12) Patent Application Publication
(10) Pub. No.: US 2006/0005979 A1
(43) Pub. Date: Jan. 12, 2006

(54) Wear-reducing structure for rotary shaft of pneumatic tool

(76) Inventor: Hsin-Chi Chen, Taiping city (TW)

Correspondence Address: DENNISON, SCHULTZ & DOUGHERTY, 612 Crystal Square 4, 1745 Jefferson Davis Highway, Arlington, VA, 22202-3417, US

(21) Appl. No.: 10/885,758

(22) Filed: Jul. 8, 2004

(51) Int. Cl. B25D 15/00

(52) U.S. Cl. 173/93

(57) ABSTRACT

A wear-reducing structure for rotary shaft of pneumatic tool, including: a rotary shaft having a predetermined length; two anvil blocks with a predetermined shape, the anvil blocks projecting from a middle section of the rotary shaft; a collar section fitted on the rotary shaft and correspondingly adjacent to the anvil blocks; and a bearing section fitted around the rotary shaft between the anvil blocks and the collar section. The bearing section includes several rolling bodies for abutting against a corresponding portion of an end face of the collar section. When the rotary shaft is rotated relative to the collar section, the rolling bodies roll relative to the collar section to reduce resistance.

### BACKGROUND OF THE INVENTION

The present invention is related to a pneumatic tool, and more particularly to a wear-reducing structure for rotary shaft of a pneumatic tool.

U.S. Pat. No. 3,174,597 discloses a technique related to a pneumatic tool. In this technique, via a pin clutch, two pin rammers ram the anvils of a rotary shaft to drive the rotary shaft. Such driving technique has been widely used in the field of pneumatic tool. However, when the rotary shaft rotates, noise and wear due to friction between metals take pace to limit the effect of the pneumatic tool. More specifically, when the rotary shaft rotates at high speed, the friction between the rotary shaft and the bush will lead to wear of the rotary shaft and the bush. Also, the friction results in loss of output power. Moreover, due to the wear of the parts, abnormal gaps will exist between the parts to enlarge the noise produced in operation of the pneumatic tool. All the above problems are not improved or solved in the prior art.

### SUMMARY OF THE INVENTION

It is therefore a primary object of the present invention to provide a wear-reducing structure for rotary shaft of a pneumatic tool, which can effectively reduce the wear of the rotary shaft and adjacent parts of the pneumatic tool when the rotary shaft rotates.

It is a further object of the present invention to provide the above wear-reducing structure for rotary shaft of the pneumatic tool, which can avoid unnecessary loss of power during transmission.

It is still a further object of the present invention to provide the above wear-reducing structure for rotary shaft of the pneumatic tool, which can reduce the noise produced when the rotary shaft rotates.

According to the above objects, the wear-reducing structure for rotary shaft of pneumatic tool of the present invention includes: a rotary shaft having a predetermined length; two anvil blocks with a predetermined shape, the anvil blocks projecting from a middle section of the rotary shaft; a collar section fitted on the rotary shaft and correspondingly adjacent to the anvil blocks; and a bearing section fitted around the rotary shaft between the anvil blocks and the collar section. The bearing section includes several rolling bodies for abutting against a corresponding portion of an end face of the collar section. When the rotary shaft is rotated relative to the collar section, the rolling bodies roll relative to the collar section to reduce resistance.

The present invention can be best understood through the following description and accompanying drawings wherein:

### BRIEF DESCRIPTION OF THE DRAWINGS

FIG. 1 is a perspective exploded view of a preferred embodiment of the present invention;

FIG. 2 is a perspective assembled view of the preferred embodiment of the present invention;

FIG. 3 is a perspective partially sectional view of the preferred embodiment of the present invention;

FIG. 4 is a cross-sectional view of the preferred embodiment of the present invention; and

FIG. 5 is a partially longitudinal sectional view of the preferred embodiment of the present invention.

### DETAILED DESCRIPTION OF THE PREFERRED EMBODIMENTS

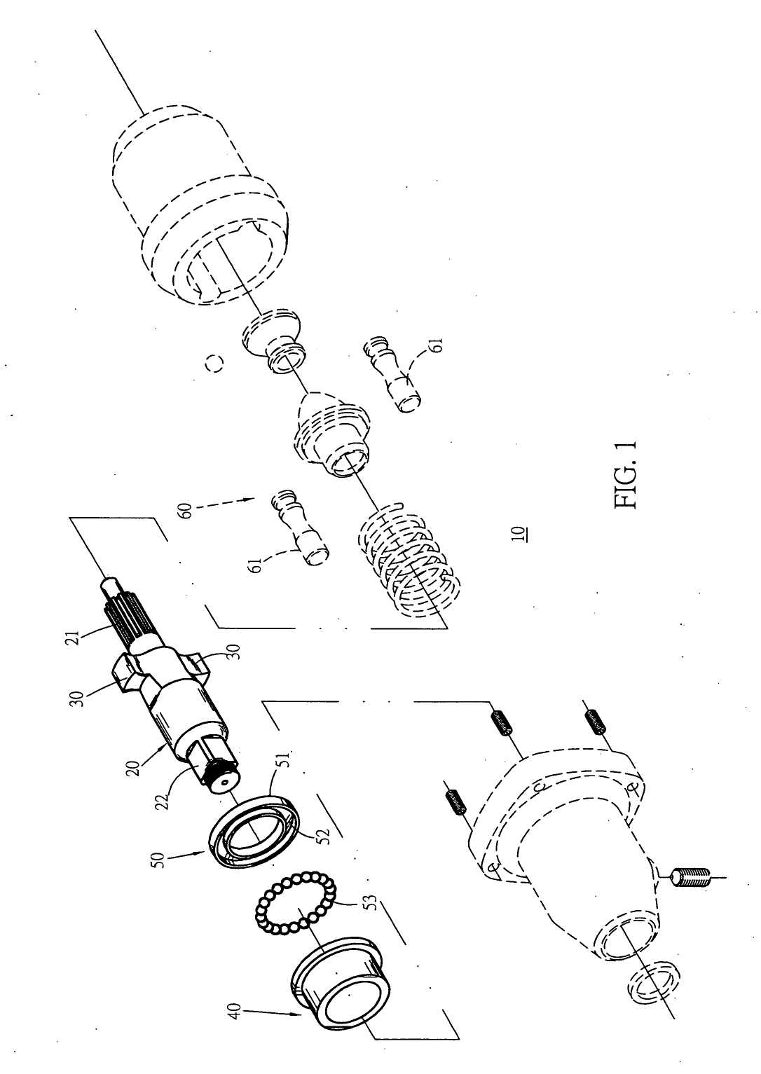

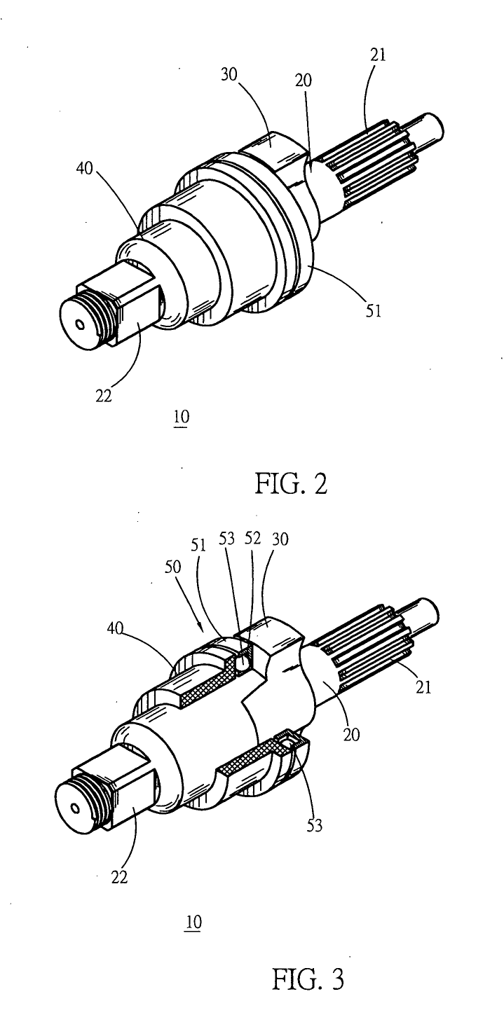

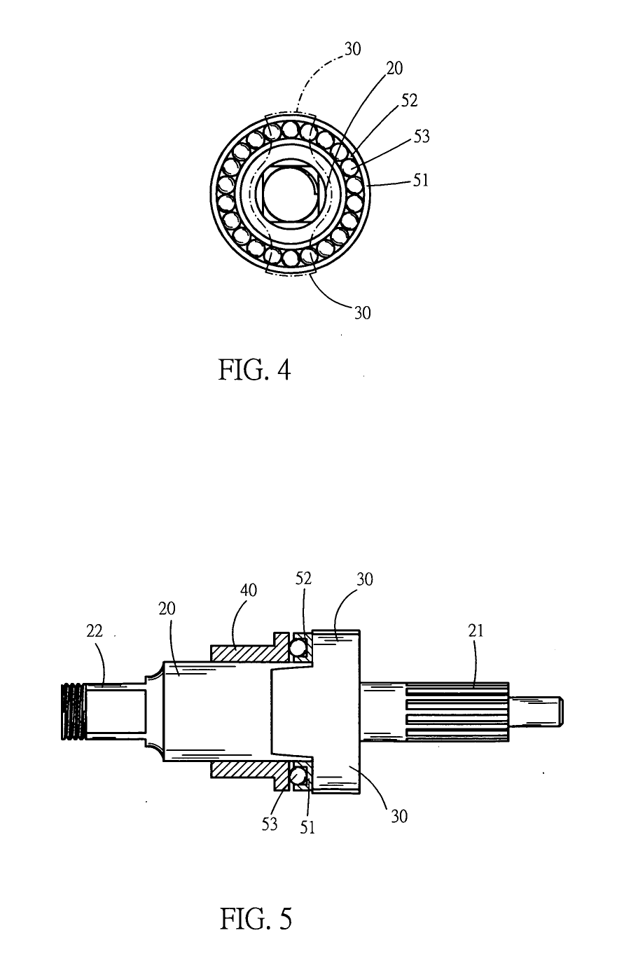

Please refer to FIGS. 1 to 5. The wear-reducing structure 10 for rotary shaft of pneumatic tool includes a rotary shaft 20, two anvil blocks 30, a collar section 40 and a bearing section 50.

The rotary shaft 20 is a rod body with a predetermined length. One end of the rotary shaft 20 is formed with multiple ratchet ribs 21. The other end of the rotary shaft 20 is formed with a quadrangular connector 22. The outer diameter of the rotary shaft 20 is varied along the axis of the rotary shaft 20. In fact, the rotary shaft 20 pertains to prior art. In other words, the rotary shaft 20 is a conventional component of a pneumatic tool.

The anvil blocks 30 back to back project from a middle section of the rotary shaft 20 at an angular interval of 180 degrees. The anvil blocks 30 are for a pin rammer 61 of a conventional ramming mechanism 60 to ram. The jaw-shaped anvil blocks 30 also pertain to prior art.

The collar section 40 is a tubular sleeve body with a certain length for fitting on one end of the rotary shaft 20. The collar section 40 is adapted to connect with a housing of the pneumatic tool for supporting the rotary shaft 20. In this embodiment, the collar section 40 is a tubular sleeve. However, in practical application, the collar section 40 is not limited to the sleeve. For example, alternatively, the collar section 40 can be a section of the housing of the pneumatic tool.

The bearing section 50 has an annular seat body 51 coaxially fitted on the rotary shaft 20 between the anvil blocks 30 and the collar section 40. The annular seat body 51 has a certain thickness. An annular groove 52 with a certain depth is formed on one face of the seat body 51 facing one end of the collar section 40. The annular groove 52 has an opening correspondingly opposite to the circumference of the end of the collar section 40. Several ball-shaped rolling bodies 53 are accommodated in the annular groove 52. The outer diameter of the rolling body 53 is slightly larger than the depth of the annular groove 52. Therefore, the rolling bodies 53 partially protrude from the opening of the annular groove 52 to abut against the circumference of the end of the collar section 40.

According to the above arrangement of the wear-reducing structure 10 for the rotary shaft of pneumatic tool, by means of the bearing section 50, the relative movement between the rotary shaft 20 and the collar section 40 is changed from the conventional sliding contact state into a rolling contact state. When the rotary shaft 20 is driven by an external power to rotate relative to the collar section 40 at high speed, the resistance can be reduced through the point contact between the rolling bodies 53 and the collar section 40 by way of rolling movement. Therefore, the loss of power can be reduced. Under the same strength of external application force, the rotational speed of the rotary shaft 20 can be enhanced. In addition, through the above rolling movement, the wear caused by friction can be reduced to enhance the durability of the components and avoid noise.

The above embodiments are only used to illustrate the present invention, not intended to limit the scope thereof. Many modifications of the above embodiments can be made without departing from the spirit of the present invention.

What is claimed is:

1. A wear-reducing structure for rotary shaft of pneumatic tool, comprising:
a rotary shaft having a predetermined length;
two anvil blocks with a predetermined shape, the anvil blocks projecting from a middle section of the rotary shaft; and
a collar section fitted on the rotary shaft and correspondingly adjacent to the anvil blocks, said wear-reducing structure being characterized in that the wear-reducing structure further comprising a bearing section fitted around the rotary shaft between the anvil blocks and the collar section, the bearing section including several rolling bodies for abutting against a corresponding portion of an end face of the collar section, whereby when the rotary shaft is rotated relative to the collar section, the rolling bodies roll relative to the collar section to reduce resistance.

2. The wear-reducing structure for the rotary shaft of the pneumatic tool as claimed in claim 1, wherein the bearing section further includes an annular seat body fitted on the rotary shaft, the rolling bodies being accommodated in the annular seat body.

3. The wear-reducing structure for the rotary shaft of the pneumatic tool as claimed in claim 2, wherein an annular groove is formed on one face of the seat body of the bearing section facing the collar section.

4. The wear-reducing structure for the rotary shaft of the pneumatic tool as claimed in claim 3, wherein the rolling bodies are ball-shaped and accommodated in the annular groove.

5. The wear-reducing structure for the rotary shaft of the pneumatic tool as claimed in claim 4, wherein an outer diameter of the rolling bodies is larger than a depth of the annular groove.
